(19) United States
(12) Patent Application Publication
(10) Pub. No.: US 2013/0213356 A1
(43) Pub. Date: Aug. 22, 2013

(54) ENGINE WORKING MACHINE

(71) Applicant: HITACHI KOKI CO., LTD., (US)

(72) Inventor: Takuhiro Murakami, Ibaraki (JP)

(73) Assignee: HITACHI KOKI CO., LTD., Tokyo (JP)

(21) Appl. No.: 13/768,414

(22) Filed: Feb. 15, 2013

(30) Foreign Application Priority Data
Feb. 17, 2012 (JP) 2012-033446

(51) Int. Cl. F02B 67/00

(52) U.S. Cl. CPC F02B 67/00
USPC 123/445

(57) ABSTRACT

There is provided an engine working machine operated by an engine including a fuel tank, a carburetor and a crankcase, wherein the engine working machine is provided with a fuel supply path configured to supply an additional fuel in an interior of a crank chamber at a time of starting and an starting aid device including a solenoid valve configured to open/close the fuel supply path. The solenoid valve provided inside the starting aid device is controlled by a control unit equipped by a control circuit board and is driven by power of the battery so as to open/close a fuel inlet hole. At the time of starting the engine, the control unit controls opening/closing the solenoid valve at an appropriate timing, so that the fuel is directly inlet to the interior of the crank chamber.

This application claims priority from Japanese Patent Application No. 2012-033446 filed on Feb. 17, 2012, the entire subject-matter of which is incorporated herein by reference.

### TECHNICAL FIELD

The present invention relates to an engine working machine in which an engine is used as a power source of a portable working machine such as a bush cutter and a blower.

### BACKGROUND

In a small working machine such as a bush cutter or a chain saw, for example, in a hand-held bush cutter, a small engine is widely used as a power source. FIG. 15 is an external view of a bush cutter 1001 which is an example of a related-art engine working machine. As shown in FIG. 15, in the bush cutter 1001 equipped with a small two-cycle engine, a drive shaft (not shown) extends through a pipe-shaped main pipe 1005 and is rotated by an engine provided at one end (first end) of the main pipe 1005. In this way, a rotating blade 1006 provided at the other end (second end) of the main pipe 1005 is rotated. A scattering protective cover 1007 for preventing the scattering of cut grass is provided in a vicinity of the rotating blade 1006. The bush cutter 1001 can be carried by a shoulder suspender belt (not shown) or the like. A handle 1004 to be operated by an operator is mounted in the vicinity of a longitudinal center portion of the main pipe 1005 and has a substantially U shape as seen from the front. Rotation number of the engine is controlled by an operator through a throttle lever (not shown) attached to a grip part 1003. Operation of the throttle lever is transmitted to a carburetor of the engine through a wire 1037. The engine used in the bush cutter 1001 has an advantage that a large output can be obtained by a compact and lightweight structure and it is possible to work for a long time by replenishing fuel. On the other hand, the engine has a disadvantage that it is necessary to reciprocate a piston by combustion of air-fuel mixture and therefore it takes more time to start the engine, as compared to an electric motor. For this reason, Patent Document 1 discloses a manual-type starting aid device having a start-up fuel supply unit, in which a proper amount of start-up fuel is accumulated in the start-up fuel supply unit and a supply push button of the start-up fuel supply unit is pressed down when a crankshaft is driven by a recoil-type starter. In this way, a proper amount of fuel reserved in the start-up fuel supply unit is supplied to the carburetor.

### SUMMARY

In order to improve the startability of the two-cycle engine of the hand-held bush cutter or the like, it is general that a manual-type choke mechanism or the manual-type starting aid device disclosed in JP-UM-B-6-49895 is provided in the carburetor. In this case, an operator to perform starting of the engine actuates the choke mechanism or the like when the engine is cold and an outside air temperature is low. By doing so, the amount of intake air to the carburetor is restricted and a negative pressure is generated, so that the fuel is forcibly sucked out from the carburetor, and thus the concentration of the air-fuel mixture sucked into a cylinder of the engine becomes rich and therefore the amount of the fuel is increased. However, in the related-art small engine, an operator manually actuates the choke mechanism or the starting aid device, so that it is necessary for the operator to determine the timing to operate the choke mechanism, the timing to release the choke mechanism and the operation amount of the choke mechanism. This acts as a burden for the operator. Further, if the operation of the choke mechanism or the starting aid device is not appropriate, it may take more time to start the engine.

Therefore, one aspect of the present invention provides an engine working machine in which the startability is improved by sucking a large amount of fuel into the engine at the time of starting the engine.

Another aspect of the present invention provides an engine working machine in which the startability is improved by providing a fuel supply path that is independent from a carburetor and using the fuel supply path together at the time of starting the engine.

Still another aspect of the present invention provides an engine working machine in which the start control of an engine is electronically performed using a small battery and a control device.

According to one illustrative aspect of the invention, there is provided an engine working machine comprising: an engine configured to operate the engine working machine, the engine comprising: a fuel tank; a cylinder in which a piston is configured to reciprocate; a carburetor configured to supply mixed gas of air and fuel fed from the fuel tank into the cylinder; and a crankcase comprising the cylinder and configured to form a crank chamber; a fuel supply path configured to supply an additional fuel in an interior of the engine at a time of starting; and an starting aid device comprising a solenoid valve configured to open/close the fuel supply path.

According thereto, the engine working machine is provided with the fuel supply path configured to supply the additional fuel in the interior of the engine at the time of starting and the starting aid device including the solenoid valve to open/close the fuel supply path. Therefore, it is possible to simplify an operation procedure at the time of starting the engine, and thus it is possible to improve the startability.

### BRIEF DESCRIPTION OF THE DRAWINGS

FIG. 1 is a longitudinal sectional view showing an internal structure of an engine working machine according to an exemplary embodiment of the present invention;

FIG. 2 is a rear view showing the engine working machine according to the exemplary embodiment of the present invention;

FIG. 3 is a perspective view showing an overall shape of an starting aid device of FIG. 1;

FIG. 4 is a bottom view showing the starting aid device of FIG. 1;

FIG. 5 is a rear view showing the starting aid device of FIG. 1;

FIG. 6 is a sectional view showing an internal structure of the starting aid device of FIG. 1, taken along line A-A of FIG. 5;

FIG. 7 is another sectional view showing the internal structure of the starting aid device of FIG. 1, taken along line A-A of FIG. 5;

FIG. 8 is a circuit diagram of the engine working machine according to the exemplary embodiment of the present invention;

FIG. 9 is a longitudinal sectional view showing an internal structure of an engine working machine according to a second exemplary embodiment of the present invention;

FIG. 10 is a perspective view showing the overall shape of an starting aid device of FIG. 9;

FIG. 11 is a side view showing the starting aid device of FIG. 9;

FIG. 12 is a rear view showing the starting aid device of FIG. 9;

FIG. 13 is a sectional view showing an internal structure of the starting aid device of FIG. 9, taken along line B-B of FIG. 9;

FIG. 14 is another sectional view showing the internal structure of the starting aid device of FIG. 9, taken along line B-B of FIG. 9;

FIG. 15 is a perspective view showing an outer appearance of a related-art engine working machine (bush cuter).

### DETAILED DESCRIPTION OF THE PREFERRED EMBODIMENTS

### First Exemplary Embodiment

Hereinafter, exemplary embodiments of the present invention will be described with reference to the accompanying drawings. In the following drawings, the same or similar reference numerals are applied to the same or similar parts and elements, and the duplicated description thereof will be omitted. Further, as used herein, a front-rear direction and an upper-lower direction are referred to the directions indicated in the drawings.

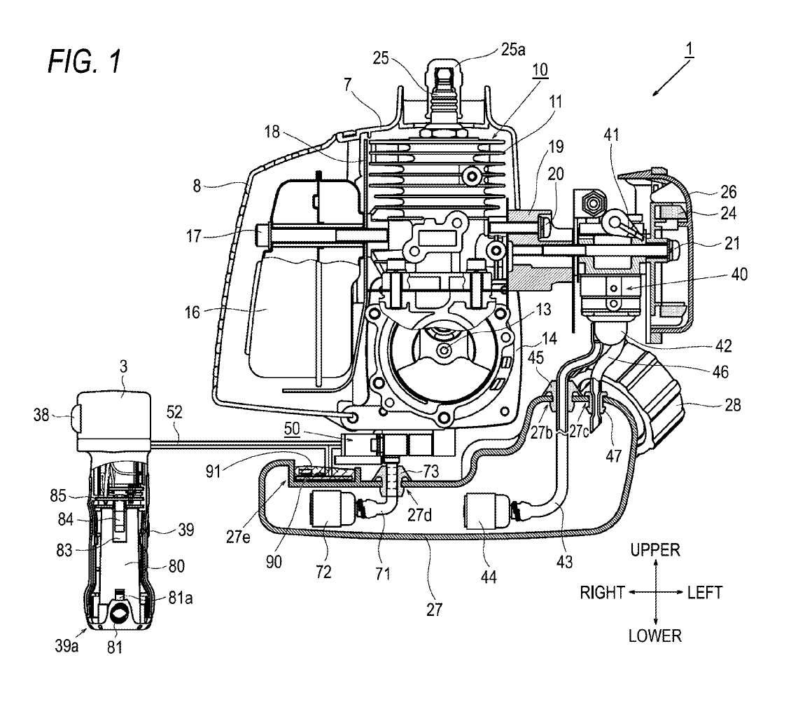

FIG. 1 is a longitudinal sectional view showing an internal structure of an engine working machine 1 according to the present exemplary embodiment. An engine 10 is a small two-cycle engine. The engine is configured so that a crankshaft 13 is arranged coaxially with a main pipe (not shown) of a bush cutter, a cylinder 11 is arranged to extend in a substantially vertical direction from a crankcase 14, and a piston (not shown) is configured to reciprocate in an up-down direction. A muffler 16 is attached to one side (first side) (right side) of the cylinder 11 by a bolt 17, and a carburetor 40 is provided at the other side (second side) (left side) of the cylinder 11.

High-voltage current is generated in an ignition coil (not shown) and transmitted to an ignition plug 25 through an ignition cord (not shown) and a plug cap 25a. In the present exemplary embodiment, an upper part of the engine 10 is covered with an upper cover 7, and the muffler 16 is covered with a muffler cover 8. The muffler 16 is configured to reduce the exhaust noise when the combustion gas discharged from the cylinder 11 is discharged to the outside. The muffler is made of metal and formed into a box shape. A plurality of expansion chambers is provided in the interior of the muffler 16, and a catalyst device for purifying the exhaust gas is also provided therein.

The upper cover 7 and the muffler cover 8 are produced by integral molding of synthetic resin such as plastic, for example. A fuel tank 27 is provided below the crankcase 14 of the engine 10. A mixed fuel of oil and gasoline for two-cycle engine is input to the fuel tank 27. The mixed fuel is sucked from the fuel tank 27 by a fuel pipe 43 extending from the carburetor 40 of the engine 10. A filter 44 is provided at a tip of the fuel pipe 43 to prevent suction of dust. The carburetor 40 is provided with a manually-actuated choke lever 41. Since the structure and operation of the choke lever 41 are well-known, a detailed description thereof is omitted herein. An insulator 19 is mounted to the cylinder 11 by a screw 20. The insulator 19 forms an intake passage between the carburetor 40 and the cylinder 11 and is configured to fix the carburetor 40. The carburetor 40 is mounted to the insulator 19 by two screws 21 (only one is shown in the figure). The carburetor 40 is provided with a priming pump 42 for sucking-up the mixed fuel from the fuel tank 27 to the carburetor 40. The priming pump 42 is a hemispherical transparent valve. Immediately before starting the engine 10, an operator repeatedly presses the priming pump 42 until the fuel flows in a return pipe 46, so that the fuel is sucked-up to the carburetor 40. The fuel tank 27 is formed with through-holes 27b, 27c for allowing the fuel pipe 43 and the return pipe 46 to extend therethrough. Rubber bushes 45, 47 respectively seal between the through-hole 27b and the fuel pipe 43 and between the through-hole 27c and the return pipe 46.

In the present exemplary embodiment, an starting aid device 50 is further provided for directly feeding additional mixed fuel to the interior of the engine 10, specifically, to the crank chamber at the time of starting the engine. A dedicated fuel pipe 71 independent from the fuel pipe 43 is connected to the starting aid device 50 to supply fuel. The fuel tank 27 is formed with an additional through-hole 27d for allowing the fuel pipe 71 to extend therethrough. A rubber bush 73 is provided between the fuel pipe 71 and the through-hole 27d to prevent leakage of the fuel. A filter 72 is provided at a tip of the fuel pipe 71 to prevent suction of dust.

The starting aid device 50 is an on-off valve of an additional fuel passage for directly feeding the mixed fuel sucked from the fuel pipe 71 to the interior of the crank chamber using a solenoid. The starting aid device 50 is driven by power of a battery 80 mounted on a handle part 3. The driving of the solenoid is controlled by a control circuit (control unit) mounted on a control circuit board 90 which is attached to an outer surface of the fuel tank 27. The control circuit board 90 is equipped with an electronic circuit configuring a control circuit such as IC. The control circuit board 90 is provided in a recess 27e which is formed at the outer surface of the fuel tank. The control circuit board 90 is covered with urethane resin 91. Although not shown in FIG. 1, the control circuit board 90 and the starting aid device 50 are connected to each other by a plurality of lead wires. The urethane resin 91 serves as an adhesive to fix the control circuit board 90 to the fuel tank 27 and also serves as a dustproof/waterproof cover by entirely coating an upper part of the control circuit board 90. That is, in the present exemplary embodiment, since the control circuit is provided to the fuel tank 27, the control circuit can be mounted together with a fuel tank assembly. Accordingly, the number of parts to be modified in a related-art engine working machine can be reduced, so that it is possible to suppress an increase in man hour or an increase in cost. Further, since the fuel tank 27 is formed with a mounting part (e.g., recess 27e), on which the control circuit is mounted, and since the control circuit board 90 equipped with the control circuit is mounted on the mounting part and is fixed by the resin to cover the control circuit board 90, the control circuit can be effectively protected from dust or water. Accordingly, it is possible to realize the engine working machine 1 with high reliability.

The handle part 3 (a part grasped by a right hand or left hand of an operator) of the starting aid device 50 is provided with a switch 38. The switch 38 is configured to activate the power of the motor and the control circuit at ON time. The switch 38 is configured to stop the engine and to reset the control circuit at OFF time. The switch 38 is a switch to switch two modes of “Operation” and “Stop”. The switch 38 is switched to “Operation” mode when starting the engine 10. The switch 38 is switched from “Operation” mode to “Stop” mode when stopping the engine 10 during operation, thereby stopping the engine 10. The handle part 3 is formed with a grip part 39, and an opening 39a is formed at an end of the grip part 39, such that the small battery 80 is mounted to an interior of the handle part 3 (grip part 39). The battery 80 has a substantially cylindrical shape and is configured into a pack form or a cassette form to allow the battery to be removably attached to the grip part 39.

For example, a plurality of lithium-ion battery cells (not shown) with 14500 size is accommodated in the interior of the battery 80. A rear end (a lower side in the figure) of the battery 80 is shaped to cover the opening 39a formed at a lower end of the grip part 39. In other words, the opening 39a is formed at one end (first end) of a mounting space of the battery 80. A terminal base 85 is provided at the other end (second end) of the mounting space of the battery 80 continued to the opening 39a. A plurality of terminals 74 is arranged to extend from the terminal base 85 toward the opening 39a. A plurality of end terminals 83 is provided at a front end (an upper side in the figure) of the battery 80. As the battery 80 is mounted to the grip part 39, the end terminals 83 are brought into contact with a terminal 84 formed at the grip part 39. In this way, the power of the battery 80 is supplied to the starting aid device 50 using a lead wire 53. That is, in the present exemplary embodiment, since the battery 80 is a removable lithium-ion battery, a large-capacity battery can be realized in a small size.

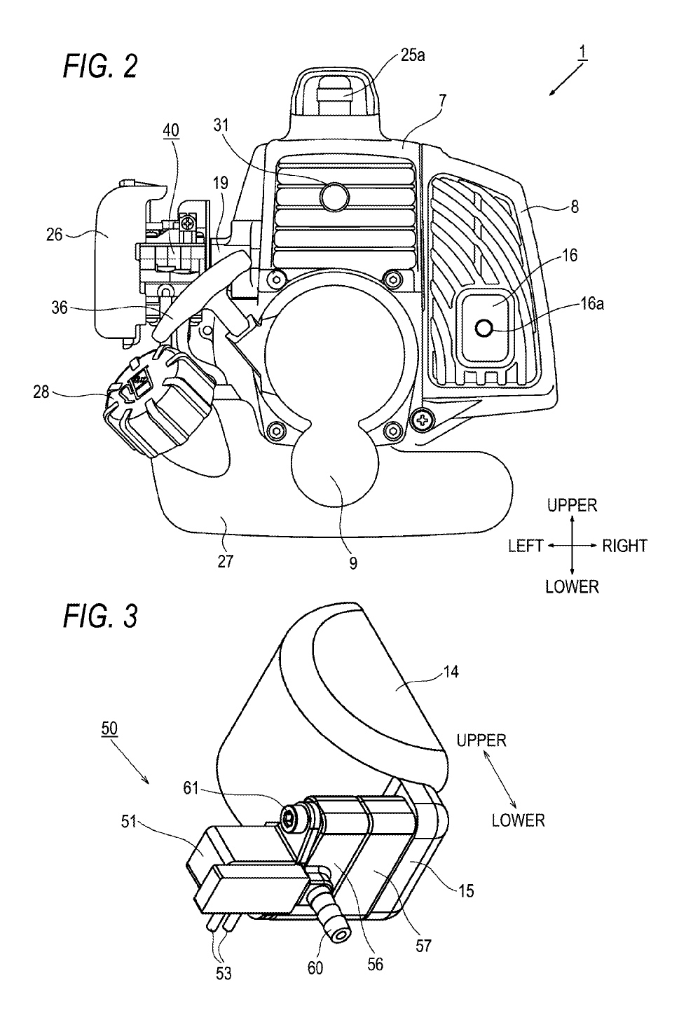

FIG. 2 is a rear view showing the engine working machine 1 according to the exemplary embodiment of the present invention. The upper part of the engine 10 (not visible in FIG. 2) is covered with the upper cover 7, and the periphery of the muffler 16 in the right side of the engine 10 is covered with the muffler cover 8. An exhaust opening 16a serving as an outlet of the exhaust gas is provided at a rear surface of the muffler 16. A recoil starter (not shown) is provided at a rear side of the engine 10 to be coaxial with the crankshaft 13. The recoil starter is covered with a starter cover 9. A starter handle 36 is provided at an upper left side of the starter cover 9. The recoil starter (not shown) is connected to an engine crankshaft 13 via a clutch around which a traction strap (not shown) is wound. The traction strap is connected to the starter handle 36. The crankshaft 13 is rotated by pulling the starter handle 36, thereby starting the engine.

The carburetor 40 is provided on a left side of the cylinder of the engine 10 with the insulator 19 interposed therebetween. The carburetor 40 is provided with an air cleaner 24 (see, FIG. 1). A space of the carburetor 40 accommodating the air cleaner 24 is covered with an air cleaner cover 26. The fuel tank 27 is provided below the crankcase 14. The fuel tank 27 is a container formed by translucent polymer resin and thus an operator can see the remaining amount of fuel from the outside. The fuel tank 27 is provided with a cylindrical opening. A mixed fuel in which gasoline and oil are mixed in a predetermined ratio can be input to the fuel tank 27 by turning a cap 28 mounted to the opening. In the present exemplary embodiment, in order to decrease the overall height of the engine working machine 1, the fuel tank 27 has a planar shape extending in a lateral direction, and thus it is possible to achieve compactness of the engine working machine 1.

FIG. 3 is a perspective view showing the overall shape of the starting aid device 50 in the engine working machine 1 according to the exemplary embodiment of the present invention. The starting aid device 50 is fixed to a mounting boss 15 by two bolts 61 (only one is shown in the figure). The mounting boss 15 projects downward from the cylindrical crankcase 14 (only a part thereof is shown in the figure). The starting aid device 50 serves to reserve the fuel which is additionally supplied to the engine for staring. In addition, the starting aid device 50 serves to suck directly the fuel into the crank chamber of the crankcase 14. Consequently, the startability of the engine 10 is enhanced. The mounting boss 15 is integrally formed with a part of the crankcase 14 which is produced into a divided form. For example, the mounting boss 15 is produced by integral molding of metal such as aluminum alloy. The starting aid device 50 includes a solenoid valve 51, a solenoid valve fixing part 56, a passage part 57 and a fuel passage 60. Two lead wires 53 are drawn out from the solenoid valve 51. Although only a part of the lead wires 53 is shown in the figure, the lead wires 53 are connected to the handle part 3 and the control circuit board 90, as shown in FIG. 1. The connection passage 60 is connected to the fuel pipe 71 (see, FIG. 1) extending from the fuel tank 27.

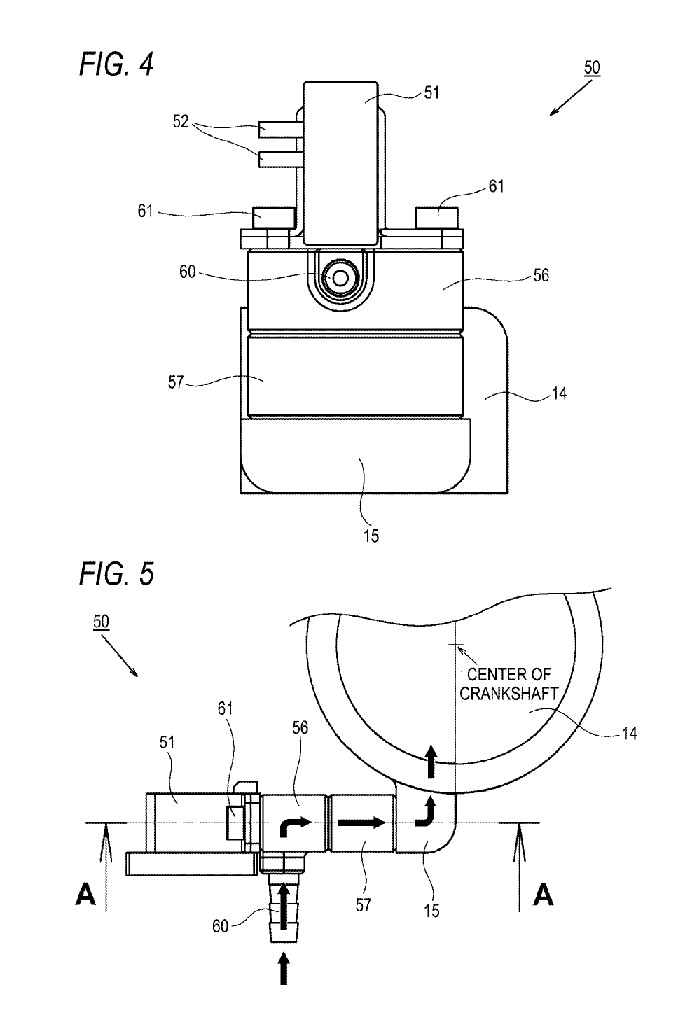

FIG. 4 is a bottom view showing the starting aid device 50. Herein, the bottom view refers to a view indicated on the basis of the direction when the starting aid device 50 is installed to the engine 10, as shown in FIG. 1. The solenoid valve 51, the passage part 57 and the solenoid valve fixing part 56 of the starting aid device 50 are fastened and attached together to the mounting boss 15 as a projecting part of the crankcase 14 by the bolts 61. The fuel passage 60 is formed into a cylindrical shape projecting vertically downwardly of the crankcase 14. An outer part of the fuel passage 60 is configured as a hose end part to allow the fuel pipe 71 to be connected directly thereto. The hose end part is formed by connecting a conical outer-diameter part in multiple.

FIG. 5 is a rear view showing the starting aid device 50 of FIG. 1. In order to allow the starting aid device 50 of the present exemplary embodiment to be mounted, a lower part of the crankcase 14 is provided with the mounting boss 15 for forming a seat surface to which the starting aid device 50 is attached. The mounting boss 15 is a substantially rectangular parallelepiped block (thick part) projecting downwardly from the crankcase 14 and integrally formed with the crankcase 14 by casting or the like. A passage (will be described later) for feeding the fuel from the starting aid device 50 to the interior of the crank chamber is provided in the inside of the mounting boss 15. The passage part 57 and the solenoid valve fixing part 56 are fixed to a left side of the mounting boss 15 in the horizontal direction by the bolts 61. The fuel passage 60 for connecting the fuel pipe 71 (see, FIG. 1) is provided at a lower side of the solenoid valve fixing part 56 and also at a side in which the fuel tank 27 is located. Like this, the starting aid device 50 is mounted directly below the crankcase 14 of the engine 10, and the fuel flows to the interior of the solenoid valve fixing part 56 through the fuel passage 60 at the time of starting the engine, as indicated by arrow of FIG. 5. The flowing direction of the fuel is changed from the vertical direction to the horizontal direction at the solenoid valve fixing part 56. The fuel flows through the interior of the passage part 57 and the interior of the mounting boss 15 and is sucked into the interior (crank chamber) of the crankcase 14. That is, according to the present exemplary embodiment, since a fuel supply path is a flow path leading to the crank chamber from the fuel tank 27 and the starting aid device 50 is provided adjacent to the crankcase 14, the additional fuel can be directly supplied to the interior of the crank chamber in the shortest distance. The mounting boss 15 is provided with a horizontal flow passage and a vertical flow passage, which are not shown in the figure. The fuel flows from the horizontal flow passage to the vertical flow passage which is open toward the crank chamber. This additional fuel suction timing is controlled with high precision in such a way that the solenoid valve 51 is electrically driven by the control circuit mounted on the control circuit board 90. The control circuit detects a proper timing (rotational position) of the crankshaft by Hall IC (not shown) arranged at an outer periphery of a magneto rotor (not shown) and opens the solenoid valve 51 at that timing. At this time, since the crank chamber is in a state of negative pressure, the mixed fuel reserved in the passage part 57 is sucked to reach the crank chamber. The fuel sucked to the crank chamber through the starting aid device 50 in this manner is additionally supplied to the engine, independently of the mixed fuel sucked through the carburetor 40. That is, it is preferable that the starting aid device 50 alone does not supply the fuel to the interior of the engine 10 but the starting aid device 50 is actuated simultaneously with the carburetor 40.

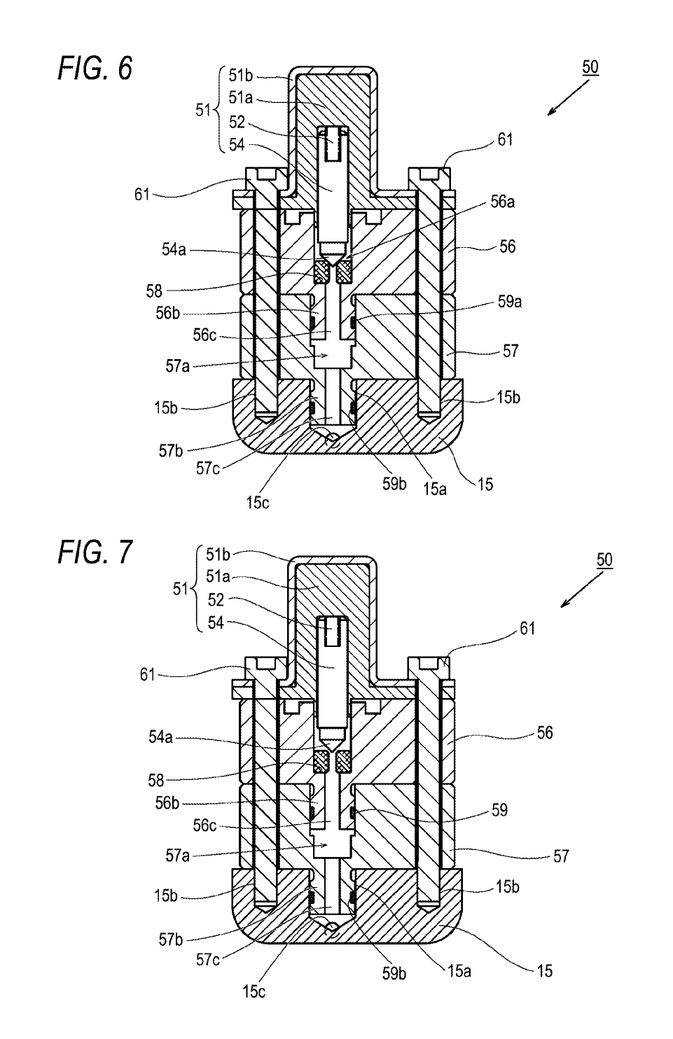

FIG. 6 is a sectional view taken along line A-A of FIG. 5, showing an internal structure of the starting aid device 50 of FIG. 1. The solenoid valve 51 controls the flow of the mixed fuel in a flow path from the fuel passage 60 (see, FIG. 5) up to the passage part 57 in such a way that a valve (a tip portion 54a) is opened and closed by moving a plunger 54 using a magnetic force of an electromagnet (solenoid). The solenoid valve 51 includes a main body unit 51a accommodating the electromagnet (not shown) and a fixation fitting 51b covering the main body unit 51a. The fixation fitting 51b covers an outer periphery of the main body unit 51a and configures a screw seat for the bolts 61. Further, the main body unit 51a is connected to the lead wire 53 (see, FIG. 3) for supplying power to the electromagnet. The fixation fitting 51b of the solenoid valve 51 is fixed to two screw holes 15b formed at the mounting boss 15 by two bolts 61. The solenoid valve fixing part 56 is formed with a fuel storage 56a connected to the fuel tank 60. A cylindrical plunger abutting part 58 is provided at an outlet of a pipe line from the fuel storage 56a toward the passage part 57.

One end (first end) of the plunger 54 is held by a movable piece 52, and the other end (second end) thereof is formed with a tip portion 54a having a conical shape. As the tip portion 54a is brought into contact with the plunger abutting part 58, the flow path is closed. And, as the tip portion 54a is spaced away from the plunger abutting part 58, the flow path is opened. A cylindrical protruding part 56b is formed at an outlet side of the solenoid valve fixing part 56. The protruding part 56b is inserted into a cylindrical space 57a of a predetermined size. An O-ring 59a is placed at a joint part of the protruding part 56b and the cylindrical space 57a to prevent the fuel from being leaked through the joint part. The passage part 57 is formed with a protruding part 57b extending to the discharge side, and a fuel passage part 57c is provided at an interior part of the protruding part 57b. The protruding part 57b is mounted in a cylindrical mounting hole 15a formed at the mounting boss 15. The mounting hole 15a has a conical bottom part at which a thorough-hole 15c leading to the interior of the crank chamber from a tip part thereof is formed. An O-ring 59b is placed at a joint part of the protruding part 57b and the mounting hole 15a to prevent the fuel from being leaked through the joint part.

FIG. 7 is a sectional view similar to FIG. 6, showing a state where a fuel flow path is opened by moving the plunger 54. The state shown in FIG. 7 is different from the state shown in FIG. 6 in the position of the plunger 54. Specifically, as the plunger 54 approaches (is pulled toward) the solenoid valve 51, the tip portion 54a is spaced away from the plunger abutting part 58, thereby opening the flow path leading to the passage part 57 from the fuel passage 60 (see, FIG. 5). By utilizing this opening timing as the timing when the crank chamber becomes negative pressure, the fuel reserved in the cylindrical space 57a is sucked into the crank chamber through the thorough-hole 15c. In the two-cycle engine, the fuel flowing into the crank chamber is fed to the cylinder 11 through a scavenging port and combusted by the ignition plug 25. That is, according to the present exemplary embodiment, since the fuel supply path by the starting aid device 50 is connected to the through-hole 15c and the solenoid valve 51 is arranged to move in a direction angled to an inlet direction to the crank chamber, it is possible to prevent reverse flow of the fuel even when the crankcase 14 becomes negative pressure or positive pressure. Further, since the starting aid device 50 includes the solenoid valve fixing part 56 and the passage part 57, it is possible to realize the engine working machine 1 capable of storing a large amount of fuel for starting to supply the fuel by the solenoid valve 51.

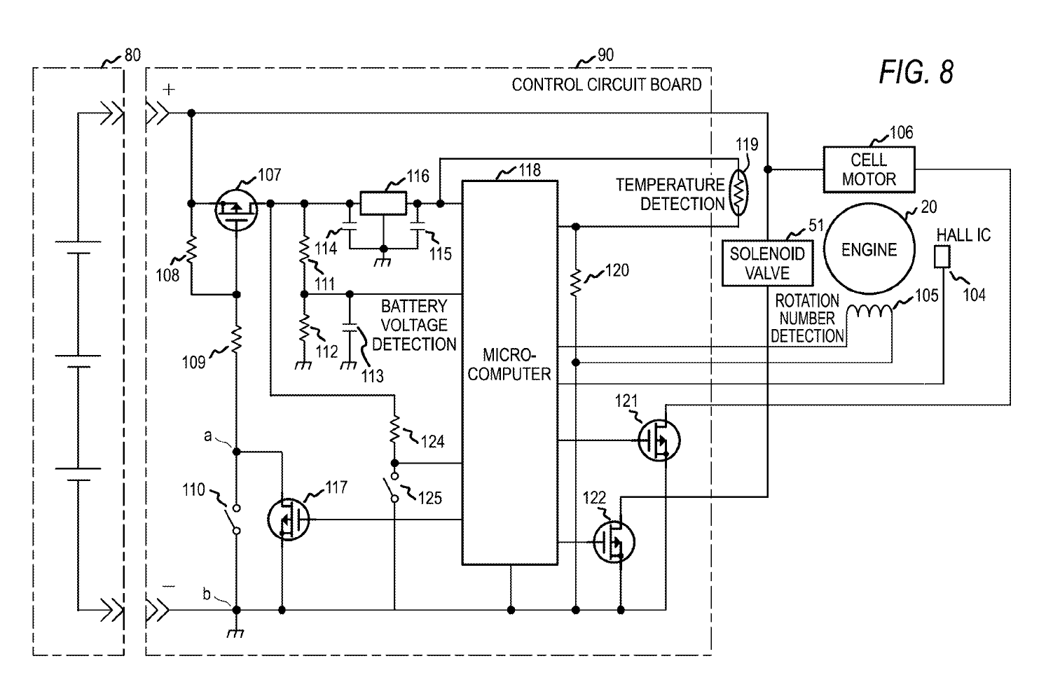

FIG. 8 is a diagram showing a circuit which is mounted on the control circuit board 90 for actuating the solenoid valve 51. The engine working machine 1 is provided with a cell motor 106 for starting the engine 10, and the battery 80 for driving the cell motor 106 is connected to the engine working machine 1. Further, the solenoid valve 51 is provided for starting the engine 10 and serves as an auto choke at the time of starting the engine 10. The cell motor 106 and the solenoid valve 51 are controlled by a micro-computer 118 mounted on the control circuit board 90. A rotation number detection coil 105 for detecting the rotation number of the engine 10 is provided to perform the control by the micro-computer 118. Four FETs 107, 117, 121 and 122, resistors 108, 109, 111, 112, 120 and 124, switches 110 and 125, capacitors 113, 114 and 115, a regulator 116, the micro-computer 118, a thermistor 119 or the like are mounted on the control circuit board 90.

The micro-computer 118 is driven by a constant voltage supplied by the regulator 116 and includes a plurality of A/D conversion ports. An output signal of the thermistor 119 indicating the temperature of the engine, a terminal voltage of the resistor 124 for detecting the open/close state of the switch 125, a signal indicating the voltage of the battery 80 by the resistors 112, 114 and an output signal of the rotation number detection coil 105 are input to the plurality of A/D conversion ports. A signal indicating the rotation of the engine is detected by converting magnetic flux from a magnet mounted on the engine 10 into voltage using the rotation number detection coil 105 and by inputting the converted voltage to the micro-computer 118. The micro-computer 118 performs a predetermined logical operation on the basis of these input values. The micro-computer 118 controls the conducting and blocking between the source and drain of FETs 117, 121, 122 by performing the transmission of the gate signals of FETs 117, 121, 122.

The FET 121 serves as a switch to rotate the cell motor 106. The source and drain of the FET 121 are conductive to each other by command (supply of gate signal) of the micro-computer 118, and thus DC current from the battery 80 is supplied to the cell motor 106 configured by DC motor. The FET 122 serves as a switch to open the solenoid valve 51. The source and drain of the FET 122 are conductive to each other by command (supply of gate signal) of the micro-computer 118 and thus the solenoid valve 51 is opened. The timing to open the solenoid valve 51 is controlled by the micro-computer 118. The micro-computer 118 controls opening/closing of the solenoid valve 51 at a proper timing using an output of Hall IC 104 arranged at a predetermined position in the outer periphery of the magneto rotor (not shown) of the engine 10. For example, when the magnet provided at the magneto rotor passes near the Hall IC 104, the plunger 54 is retreated to supply the fuel at the timing when opening time is 10 ms and opening number of times is 10. The timing to supply additional fuel by the solenoid valve 51 can be changed by changing the setting position of the Hall IC 104. Further, the supply amount of the fuel can be changed by changing the opening time or the opening number of times of the solenoid valve 51. That is, according to the present exemplary embodiment, since the engine working machine 1 is provided with the control circuit to control the opening/closing of the solenoid valve 51 by power of the battery 80, the starting aid device 50 can be controlled electronically. Further, since the control circuit controls the opening/closing timing of the solenoid valve 51 based on the output of a temperature measuring unit (e.g., thermistor 119) and a rotation detection unit (e.g., rotation number detection coil 105), it is possible to perform the starting control with high precision. Accordingly, the engine working machine 1 can be reliably started.

According to the present exemplary embodiment, the starting aid device 50 actuated by the control circuit is mounted to the crankcase 14 to provide an independent fuel supply path for starting, independently of the fuel supply passage leading to the engine 10 from the carburetor 40. The fuel supply path for starting is configured so that the flowing of the fuel into the crank chamber is controlled by the plunger 54 of the solenoid valve 51 to provide an optimal supply amount at an optimal timing in accordance with an ambient temperature or the temperature of the engine 10 and a crank angle. As a result, the time required to feed the fuel for starting to the crank chamber of the crankcase 14 can be shortened, and therefore, the startability can be enhanced. Further, by providing the fuel supply passage independently of the fuel supply passage for the carburetor 40 and by arranging the solenoid valve at a right angle to the fuel flowing direction, it is possible to reliably prevent reverse flow of the fuel even when the crank chamber becomes positive pressure. Furthermore, since the starting aid device and the fuel tank can be integrally mounted to the engine, it is possible to facilitate the standardization of parts with the related-art engine working machine. Still further, since the fuel tank 27 is placed directly below the crankcase 14 and a fuel supply path leading to the through-hole 15c from the fuel tank 27 and a fuel supply path from the fuel tank to the carburetor 40 are provided independently from each other, it is possible to shorten the additional fuel supply passage, and therefore, it is possible to shorten the time for the fuel for starting to reach the crank chamber. Further, with this configuration, the starting aid device 50 can be easily mounted to the engine working machine 1. Incidentally, although the engine working machine 1 including both the cell motor 106 and the manual recoil starter has been described in the above-described exemplary embodiment, the engine working machine may include only the recoil starter. Further, since the choke means is also provided at the carburetor 40 even when the engine 10 is started using the recoil starter, it is possible to perform the same engine starting operation as the related-art engine working machine even when the voltage of the battery 80 is not sufficient or the battery 80 itself is not mounted.

### Second Exemplary Embodiment

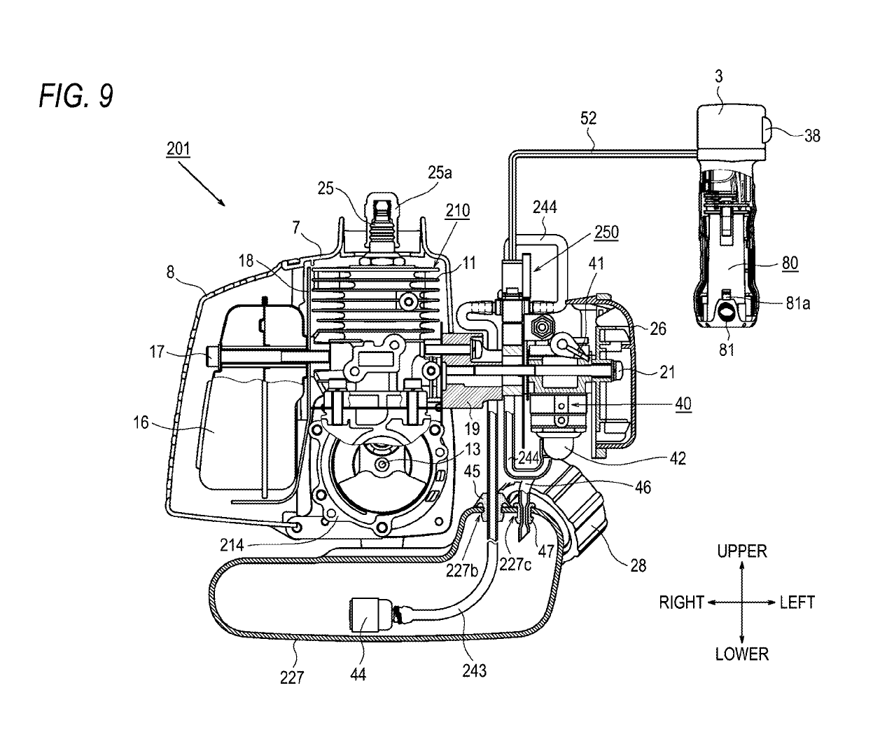

Next, a configuration of an engine working machine 201 according to a second exemplary embodiment of the present invention will be described with reference to FIGS. 9 to 14. In the following description, the same or similar element will be denoted by the same reference numeral as that of the first exemplary embodiment and the duplicated explanation thereof will be omitted.

FIG. 9 is a longitudinal sectional view showing an internal structure of the engine working machine 201 according to the second exemplary embodiment. Basic configurations such as the cylinder 11, the crankshaft 13 and muffler 16 of an engine 210 are the same as the engine 10 described above. However, the second exemplary embodiment is different from the first exemplary embodiment in that an starting aid device 250 to supply additional fuel to the interior of the cylinder at the time of starting the engine 210 is provided not below a crankcase 214 but between the insulator 19 and the carburetor 40. Further, instead of preparing a dedicated fuel pipe to supply the additional fuel to the starting aid device 250, the starting aid device 250 is interposed in the middle route of a fuel pipe 243 to supply the fuel to the carburetor 40. Accordingly, although the fuel pipe 243 for supplying the fuel from the fuel tank 227 to the carburetor 40 is provided, an end of the fuel pipe 243 is connected to the starting aid device 250. A fuel pipe 244 for connection extends from the starting aid device 250 and is connected to an inlet (not shown) of the carburetor 40. The return pipe 46 is connected to a surplus fuel discharge port (not shown) of the carburetor 40, and an end of the return pipe 46 is open toward the inside of the fuel tank 227 through a through-hole 227c.

Since the starting aid device 250 is disposed between the insulator 19 and the carburetor 40 and provided on the route of the fuel pipe 243 for supplying the fuel, the fuel tank having two through-holes 227b, 227c in addition to a related-art configuration can be used as the fuel tank 227. Further, since there is no need to change the configuration of the insulator 19 and the carburetor 40, it is not necessary to change the related-art components when realizing the present exemplary embodiment. Accordingly, it is possible to easily realize the present exemplary embodiment. Incidentally, the second exemplary embodiment is the same as the prior art and the first exemplary embodiment in that the filter 44 to prevent suction of dust is provided at a tip of the fuel pipe 244 on the side of the fuel tank 227 and the rubber bushes 45, 47 to prevent leakage of the fuel are provided at the through-holes 227b, 227c. Since a related-art fuel tank is used as the fuel tank 227 of FIG. 9, the fuel tank 227 is not provided with a dedicated space for mounting the control circuit board 90. Accordingly, the control circuit board 90 may be provided at any position of the engine working machine 201.

The carburetor 40 is provided with the priming pump 42 for sucking-up the mixed fuel from the fuel tank 27 to the carburetor 40. The priming pump 42 is a hemispherical transparent valve. Immediately before starting the engine 10, an operator repeatedly presses the priming pump 42 until the fuel flows in a return pipe 46, so that the fuel is sucked-up to the carburetor 40. Since the priming pump 42 is a hemispherical transparent valve, the operator can visually confirm that the fuel reaches the carburetor 40 when the mixed fuel reaches the transparent valve part. The operation for sucking-up the fuel to the carburetor 40 has been conventionally performed. However, in the second exemplary embodiment, since the starting aid device 250 is provided in the middle route of the fuel pipe 243 to supply the fuel to the carburetor 40, completion of the operation for sucking-up the fuel to the carburetor 40 means that the operation for sucking-up the fuel to the starting aid device 250 is completed. Accordingly, it is possible to reliably prevent a trouble that the fuel does not reach the starting aid device 250 at the time of starting the engine.

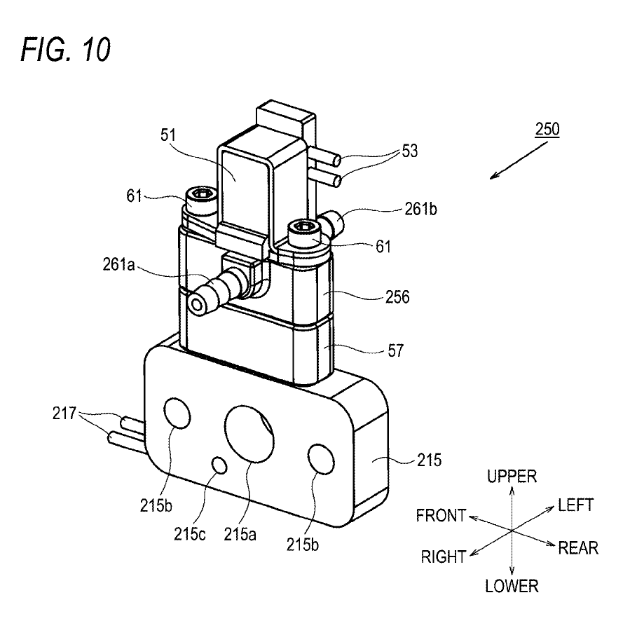

FIG. 10 is a perspective view showing the overall shape of the starting aid device 250 according to the second exemplary embodiment. In the second exemplary embodiment, the starting aid device 250 includes a fixing adapter 215. As the fixing adapter 215 is fixed between the carburetor 40 and the insulator 19, the starting aid device 250 is fixed to the engine 210. The sectional shape of the fixing adapter 215 is the same as that of the insulator 19. An intake passage 215a is provided at a center of the fixing adapter 215. Further, the fixing adapter 215 is formed with two screw holes 215b for the screws 21 at both sides of the intake passage 215a, and a pulse hole 215c. The pulse hole 215c is configured to transmit the pressure of the crankcase to the carburetor 40 and thus to operate a diaphragm (not shown). It is preferable that the fixing adapter 215 is produced by integral molding of the same resin as the insulator 19 or is produced by the same aluminum alloy as the carburetor 40. The passage part 57 is disposed on an upper side of the fixing adapter 215, a solenoid valve fixing part 256 is disposed on an upper side of the passage part 57 and the solenoid valve 51 is disposed on an upper side of the solenoid valve fixing part 256. The passage part 57, the solenoid valve fixing part 256 and the solenoid valve 51 are fixed to the fixing adapter 215 by the screws 61. The solenoid valve fixing part 256 is provided with a fuel inlet passage 261a to supply the fuel into the starting aid device 250, and a fuel discharge passage 261b to discharge the fuel from the starting aid device 250. Flow path extending from the fuel inlet passage 261a toward the fuel discharge passage 261b is arranged in a straight line, so that fuel supply from the fuel tank 227 to the carburetor 40 is not hindered. Two lead wires 53 are provided to extend from the solenoid valve 51.

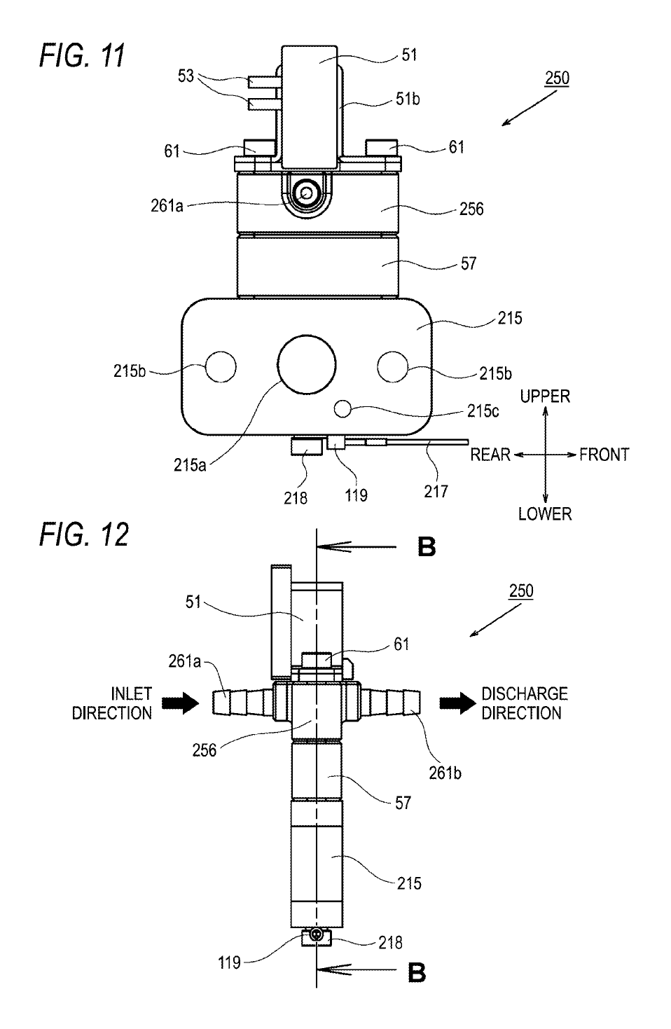

FIG. 11 is a side view showing the starting aid device 250. Herein, the side view refers to a view indicated on the basis of the direction of arrow shown in FIG. 9. The sectional shape of the fixing adapter 215 is the same as that of the mounting surface of the insulator 19 (see, FIG. 1) on the side of the carburetor 40. The intake passage 215a is provided near the center of the fixing adapter 215, and the two screw holes 215b are provided at both sides of the intake passage 215a (in a front-rear direction). Among the components of the starting aid device 250, the solenoid valve 51 and the passage part 57 can be used the same as the components of the starting aid device 50 of the first exemplary embodiment. So long as it is seen from a FIG. 11 side, the shape (right shape) of the solenoid valve fixing part 256 is the same as the shape in FIG. 4. Together with the solenoid valve 51, the solenoid valve fixing part 256 and the passage part 57 are screwed to the fixing adapter 215 by two bolts. The pulse hole 215c is provided at a location slightly below between the front screw hole 215b and the intake passage 215a. The thermistor 119 is provided below the fixing adapter 215. The thermistor 119 is configured to detect the temperature of the engine 210 by measuring the temperature of the fixing adapter 215. For example, the thermistor 119 is caulked and fixed to an R-shaped (rounded) crimping terminal, and then the crimping terminal is fixed to the fixing adapter 215 by a bolt 218. The output of the thermistor 119 is input to the micro-computer 118 (see, FIG. 8) on the control circuit board by a lead wire 217.

FIG. 12 is a rear view showing the starting aid device 250 of FIG. 9. Since the starting aid device 250 of the present exemplary embodiment is mounted, the distance between the carburetor 40 and the insulator 19 is spaced apart by the thickness (lateral width) of the fixing adapter 215. However, since it is sufficient that the thickness is substantially equal to the thickness of the solenoid valve 51, the mounting of the starting aid device 250 does not cause a problem for the length of the intake passage. When it is tried to adjust the intake passage, the shape of the insulator 19 can be changed and thus a related-art carburetor can be used as the carburetor 40. Unlike the starting aid device 50 of the first exemplary embodiment, the starting aid device 250 of the present exemplary embodiment is provided with the fuel discharge passage 261b, in addition to the fuel inlet passage 261a. This is intended to use the fuel supply path extending from the fuel tank 227 to the starting aid device 250 not as a dedicated supply path, but also as the fuel pipe 243 to feed the fuel from the fuel tank 227 to the carburetor 40. Most of the fuel supplied from the fuel tank 227 to the starting aid device 250 through the fuel pipe 243 is discharged through the fuel discharge passage 261b and is supplied to the carburetor 40 through the fuel pipe 244. Accordingly, it is important that the fuel passage from the fuel inlet passage 261a to the fuel discharge passage 261b is configured to have a low flow resistance. In the present exemplary embodiment, the inlet direction and the discharge direction are configured to be positioned in a straight line. Incidentally, the inlet direction and the discharge direction may not be positioned in a straight line. For example, the inlet direction and the discharge direction may be configured to be bent at a right angle, as long as the flow resistance can be sufficiently reduced. When there is no constraint in the inlet direction and the discharge direction, it is possible to reduce constraint in the mounting of the starting aid device 250.

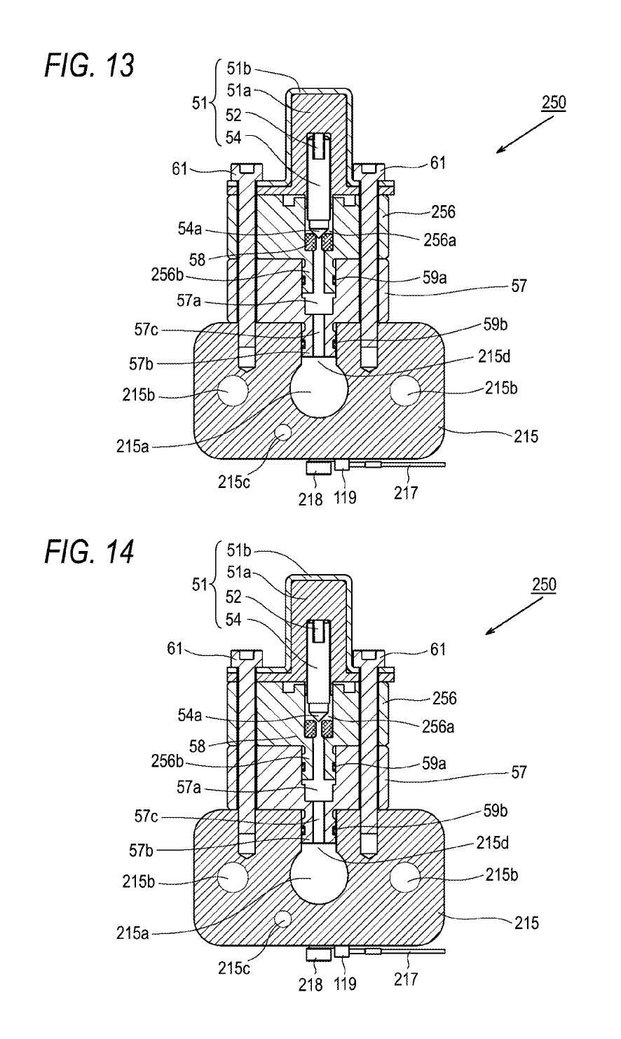

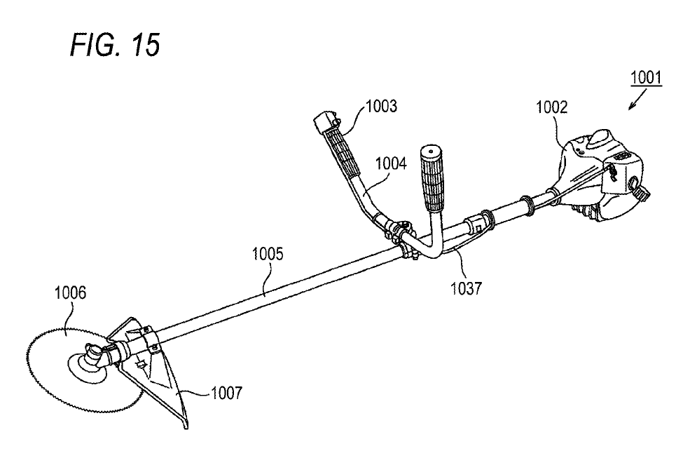

FIG. 13 is a sectional view taken along line B-B of FIG. 9, showing an internal structure of the starting aid device 250. The solenoid valve 51 and the passage part 57 are common parts with the starting aid device 50 of the first exemplary embodiment, and the shape thereof is the same. The sectional shape of the solenoid valve fixing part 256 is the same as that of the solenoid valve fixing part 56 of the first exemplary embodiment, except for that the fuel discharge passage 261b is provided. The plunger abutting part 58 is provided at a front of the plunger 54. As the tip portion 54a of the plunger 54 is brought into contact with the plunger abutting part 58, the communication of a space 256a of the solenoid valve fixing part 256 and the cylindrical space 57a is blocked. The starting aid device 250 controls the flow of the mixed fuel to a flow path branched to the passage part 57 from the fuel inlet passage 261a in such a way that a valve (tip portion 54a) is opened and closed by moving the plunger 54 using a magnetic force of the electromagnet (solenoid). A cylindrical protruding part 256b is formed at an outlet side of the solenoid valve fixing part 256. The protruding part 256b is inserted into the cylindrical space 57a of a predetermined size. The O-ring 59a is placed at a joint part of the protruding part 256b and the cylindrical space 57a to prevent the fuel from being leaked through the joint part. The passage part 57 is formed with the protruding part 57b extending to the discharge side, and the fuel passage part 57c is formed at an interior part of the protruding part 57b. The protruding part 57b is connected to a mounting hole 215d which is communicated with the intake passage 215a formed at the fixing adapter 215. The mounting hole 215d is a cylindrical hole which is formed downwardly from an upper surface of the fixing adapter 215 and penetrated to the intake passage 215a. The O-ring 59b is placed at a joint part of the protruding part 57b and the mounting hole 215d to prevent the fuel from being leaked through the joint part.

FIG. 14 is a sectional view similar to FIG. 13, showing a state where the fuel path is opened by moving the plunger 54. It will be understood that the position of the plunger 54 approaches the solenoid valve 51 and therefore the tip portion 54a is spaced apart from the plunger abutting part 58, compared with the state of FIG. 13. With this operation, a part of the fuel flowing from the fuel inlet passage 261a flows into the cylindrical space 57a, and the remaining fuel is discharged to the carburetor 40 from the fuel discharge passage 261b. The opening/closing control of the solenoid valve 51 is the same as described in FIG. 8 and is performed using the micro-computer 118.

According to the second exemplary embodiment, it is possible to realize the starting aid device capable of preventing a malfunction, in addition to simply storing and supplying a large amount of fuel. Accordingly, the startability of the engine working machine can be significantly improved. Further, since the thermistor is placed in the member (such as the fixing adapter) in the vicinity of the cylinder, an additional supply amount of the fuel for starting through the starting aid device is varied by controlling the temperature and the fuel supply timing becomes constant by controlling the rotation number by the Hall IC, it is possible to achieve an optimal start control in accordance with situation. Still further, since the insulator 19 is provided between the carburetor 40 and the cylinder 11 and connects the carburetor 40 and the cylinder 11 to form the intake passage, and since the starting aid device 250 is provided between the insulator 19 and the carburetor 11, the starting aid device 250 can be easily added without modifying a related-art engine working machine. Still further, since the starting aid device 250 includes a mounting adapter 215 configured to connect the insulator 19 and the carburetor 40 and to form the intake passage and the additional fuel supply path is open toward the intake passage 215a of the mounting adapter, it is possible to realize the starting aid device 250 having an opening independently of the intake passage from the carburetor 11. Accordingly, it is possible to realize the starting aid device 250 with high reliability. Still further, since the moving direction of the solenoid valve 51 is angled to the intake passage, a second through-hole (e.g., mounting hole 215d) formed at the mounting adapter 215 can be reliably closed. Accordingly, it is possible to prevent a trouble such as fuel leakage.

Still further, since the starting aid device 250 is connected to the middle of the fuel supply passage to supply the fuel from the fuel tank 227 to the carburetor 11, a related-art fuel tank can be used without changing the shape thereof. Further, a fuel hose prepared for the starting aid device 250 can have a minimum length, and therefore it is possible to suppress an increase in cost. Still further, since the starting aid device 250 is provided with a fuel inlet path (e.g., fuel inlet passage 261a) and a surplus fuel discharge path (e.g., fuel discharge passage 261b), and since the surplus fuel discharge path is connected to a fuel supply passage (e.g., fuel pipe 244) leading to the carburetor 11, the starting aid device 250 can be easily connected to the middle of a fuel hose of a related-art machine. Still further, since the starting aid device 250 includes the solenoid valve fixing part 256 and the passage part 57, it is possible to realize the engine working machine 201 which stores a large amount of fuel for starting to supply the fuel by the solenoid valve 51.

Incidentally, the second exemplary embodiment can be variously changed. For example, the starting aid device 250 may be configured to be provided not at the middle of the fuel pipe 243 but at the middle of the return pipe 46. Further, similar to the first exemplary embodiment, an independent dedicated fuel pipe may be provided at the starting aid device 250.

Hereinabove, the present invention has been described with reference to the exemplary embodiments. However, the present invention is not limited to the above-described exemplary embodiments, but a variety of changes can be made without departing from the scope of the invention. For example, although the engine working machine which is applied to the bush cutter has been described in the above-described exemplary embodiment, the present invention is not limited to the bush cutter, but may be similarly applied to the other engine working machines such as a chain saw, a cutter. Further, although the two-cycle engine has been described in the above-described exemplary embodiments, the present invention is not limited to the two-cycle engine, but may be similarly applied to a four-cycle engine. In addition, although the battery is provided at the handle part in the above-described exemplary embodiments, the battery may be provided in other places. For example, the battery may be provided in the inside of the cover covering the engine or may be provided in the fuel tank. Further, although the engine having the cell motor has been described in the above-described exemplary embodiments, the starting aid device of the present invention may be similarly applied to the engine having no the cell motor.

What is claimed is:

1. An engine working machine comprising:
an engine configured to operate the engine working machine, the engine comprising:
a fuel tank;
a cylinder in which a piston is configured to reciprocate;
a carburetor configured to supply mixed gas of air and fuel fed from the fuel tank into the cylinder; and
a crankcase comprising the cylinder and configured to form a crank chamber;
a fuel supply path configured to supply an additional fuel in an interior of the engine at a time of starting; and
an starting aid device comprising a solenoid valve configured to open/close the fuel supply path.

2. The engine working machine according to claim 1, further comprising:
a battery; and
a control circuit configured to control the opening/closing of the solenoid valve by power of the battery.

3. The engine working machine according to claim 2, further comprising:
a temperature measuring unit configured to measure a temperature of the engine; and
a rotation detection unit configured to detect a rotation of the engine,
wherein the control circuit is configured to control the opening/closing timing of the solenoid valve based on outputs of the temperature measuring unit and the rotation detection unit.

4. The engine working machine according to claim 2,
wherein the control circuit is provided to the fuel tank.

5. The engine working machine according to claim 2,
wherein the battery is a removable lithium-ion battery.

6. The engine working machine according to claim 4,
wherein the fuel supply path is a flow path leading to the crank chamber from the fuel tank, and
wherein the starting aid device is provided adjacent to the crankcase.

7. The engine working machine according to claim 6,
wherein the crankcase comprises a through-hole connecting the crank chamber to an outside,
wherein the fuel supply path from the starting aid device is connected to the through-hole, and
wherein the solenoid valve is arranged to move in a direction angled to an inlet direction to the crank chamber.

8. The engine working machine according to claim 7,
wherein the fuel tank is placed directly below the crankcase, and
wherein the engine working machine further comprises a fuel supply path from the fuel tank to the carburetor that is provided independently from the fuel supply path leading to the through-hole from the fuel tank.

9. The engine working machine according to claim 8,
wherein the fuel tank is formed with a mounting part, on which the control circuit is mounted, and
wherein a control circuit board equipped with the control circuit is mounted on the mounting part and is fixed by resin to cover the control circuit board.

10. The engine working machine according to claim 7,
wherein the starting aid device comprises:
a solenoid valve fixing part connected to a fuel inlet path and configured to perform a valve operation by movement of a plunger of the solenoid valve;
a passage part provided at a downstream side of the solenoid valve fixing part; and
a plunger part disposed adjacent to a side of the solenoid valve fixing part opposite to the passage part, and
wherein a discharge passage from the passage part is connected to the through hole.

11. The engine working machine according to claim 4, further comprising:
an insulator provided between the carburetor and the cylinder, the insulator connecting the carburetor and the cylinder to form an intake passage, and
wherein the starting aid device is provided between the insulator and the carburetor.

12. The engine working machine according to claim 11,
wherein the starting aid device is configured to connect the insulator and the carburetor and comprises a mounting adapter in which the intake passage is formed, and
wherein the fuel supply path is open toward the intake passage of the mounting adapter.

13. The engine working machine according to claim 12,
wherein the mounting adapter comprises a second through-hole which is provided in a direction angled to the intake passage, and
wherein a moving direction of the solenoid valve is angled to the intake passage.

14. The engine working machine according to claim 13, further comprising:
a fuel supply passage configured to supply the fuel from the fuel tank to the carburetor, and
wherein the starting aid device is connected to the middle of the fuel supply passage.

15. The engine working machine according to claim 14,
wherein the starting aid device comprises a fuel inlet path and a surplus fuel discharge path,
wherein the fuel inlet path is connected to a fuel supply passage extending from the fuel tank, and
wherein the surplus fuel discharge path is connected to a fuel supply passage leading to the carburetor.

16. The engine working machine according to claim 13,
wherein the starting aid device comprises:
a solenoid valve fixing part connected to a fuel inlet path and configured to perform a valve operation by movement of a plunger of the solenoid valve;
a passage part provided at a downstream side of the solenoid valve fixing part; and
a plunger part disposed adjacent to a side of the solenoid valve fixing part opposite to the passage part, and
wherein a discharge passage from the passage part is connected to the second through hole.
